(19) United States
(12) Patent Application Publication
(10) Pub. No.: US 2009/0187559 A1
(43) Pub. Date: Jul. 23, 2009

(54) METHOD OF ANALYZING UNSTRUCTURED DOCUMENTS TO PREDICT ASSET VALUE PERFORMANCE

(76) Inventors: Peter Gloor, Cambridge, MA (US); Jonas Sebastian Krauss, St. Augustin (DE); Stefan Nann, Cologne (DE)

Correspondence Address: Peter A. Gloor, 25 Rindgefield Street, Cambridge, MA, 02140, US

(21) Appl. No.: 12/346,484

(22) Filed: Dec. 30, 2008

Related U.S. Application Data
(60) Provisional application No. 61/021,637, filed on Jan. 17, 2008.

(51) Int. Cl. G06F 17/30

(52) U.S. Cl. 707/5; 707/E17.108

(57) ABSTRACT

A method and system is disclosed for determining the changes in valuation of an asset of interest and then using high or low betweeness centrality values as an indicator for near term future changes in asset value. The present invention searches a broad set of electronically based documents, such as Web pages, blog entries, and online forum posts that are relevant to the asset of interest, in a manner that identifies the interlinking characteristics between the documents. It also weights query terms (=asset of interest) by information retrieval metrics, and calculates the sentiment of their context.

### CROSS-REFERENCE TO RELATED APPLICATIONS

This application is related to and claims priority from earlier filed U.S. Provisional Patent Application 61/021,637 filed Jan 17, 2008.

### BACKGROUND OF THE INVENTION

The present invention relates generally to a system for measuring and analyzing the strength of interrelationships between documents in order to predict the performance of the underlying asset value performance. More specifically, the present invention relates to a system that automatically identifies certain relationships that exist between the various unrelated documents, weights the relative frequency of these relationships and then presents the relationships in a graphical depiction that predicts the performance of the asset value underlying those documents. For example, the network relationship of unrelated documents may be various Web page and blog entries that are related to or refer back to an underlying asset of interest whereby analysis of the interrelationships provides an indication of the future performance of the asset value.

In general, the basic goal of any stock selection system is to identify relevant data that is highly relevant to the user's stated objective of selecting a stock that has the potential for future growth and performance. Further, a cottage industry has developed on the Internet wherein individual inventors are attempting to capitalize on the “buy low, sell high” mantra of financial traders. In this regard, traders generally attempt to buy stocks at a low price then sell at a higher price to net a financial gain. However, predicting the best time to buy or sell a stock is difficult. In theory, and with the benefit of hindsight, it has been recognized that stocks at times follow a momentum life cycle where stock sales over time will shift from high-volume to low-volume and back again against winning and losing (increasing or decreasing stock price). Accordingly, price momentum, reversal and trading volume all suggest that stocks and portfolios go through periods of investor favoritism and neglect.

While a correlation to a particular stock's trading volume and turnover provide information useful in determining a stock value they tend to be a lagging indicator of performance. For example, when a stock becomes popular, trading volume increases. Conversely, when a stock becomes unpopular, trading volume declines. Accordingly, trading volume is a measure of the current favoritism or neglect of a stock. However, since this conventional approach is a lagging indicator, it does not readily predict where a given stock is on the momentum life cycle, nor does it provide ready selection of a portfolio of stocks during which an investor may exploit the momentum life cycle.

Therefore, there is a need for an ability to apply an automatic system to the analysis of discrete groups of documents related to a discrete asset in order to measure and visualize the interrelationships and the strengths of those interrelationships thereby identifying the potential for a leading indicator of an inflection point in the value of that asset. In other words, there is a need for an ability to apply a degree of separation search to a set of relevant documents related to a particular asset in order to determine their overall relevance to one another thereby providing a leading indicator of likely asset value inflection points of particularly high relevance.

### BRIEF SUMMARY OF THE INVENTION

In this regard, the present invention provides a system for determining the changes in valuation of an asset of interest and then using high or low betweeness centrality values as an indicator for near term future changes in asset value. In operation, the present invention searches a broad set of electronically based documents, such as Web pages, blog entries, and online forum posts that are relevant to the asset of interest, in a manner that identifies the interlinking characteristics between the documents. The interlinking characteristics are then analyzed using a betweenness centrality algorithm to calculate the relative strength of the interlinking relationships to identify and create the shortest search paths that lead a user to results having the highest betweeness centrality or having the highest relevance. Using the search system of the present invention, connections between the interlinked sets of documents are analyzed to determine their contextual strength in order to quickly and easily identify a high level of correlation or buzz surrounding a particular asset of interest that may not be immediately visible upon the face of the base documents.

In the system of the present invention assets may include stocks, bonds, currencies, box office returns, or even brand values. In this context, the present invention provides a system wherein a first level of searching is conducted to identify all of the available results that are related to the asset of interest. The available results are collected from three sources, namely, the wisdom of crowds (Web sites), the wisdom of (self-proclaimed) experts in their blogs and the wisdom of swarms (online forums). Those results are mined to identify a second (and subsequent) level search result containing all of the pages that are linked to from the set of results that are identified in the previous search level. All of the iterative search results are then analyzed in a manner that creates a list of the interlinking data between each of the documents in the result in order to connect that document into the network. Then using the interlinking information in the network, the betweenness for each node in each of the three categories is calculated such that the betweeness is a measure of the centrality of a node in a network. It may be characterized loosely as the number of times that a node needs a given node to reach another node. It is usually calculated as the fraction of shortest paths between node pairs that pass through the node of interest. Accordingly, betweeness ranges from 0, for nodes that are totally peripheral, to 1, for nodes that are on all shortest paths. Then the betweeness scores are mixed to form a composite betweeness value.

The present system has recognized that those underlying assets that have a change from low to high betweeness value are likely to experience a corresponding and related change in asset valuation. Further, it has been determined that betweeness values have a leading indicator effect with respect to the change in asset valuation. In other words, changes in betweeness of an asset translates to a future change in asset valuation. The power of the system of the present invention is derived from the ability to produce a search result that identifies in real time changes in betweeness of assets being tracked in a manner that provides a leading indicator for upcoming changes in the asset valuation.

It should be appreciated that this analysis can be done using a snapshot in time or could be formed as a temporal analysis. Further, the temporal curves of betweeness values of search terms (the stocks, company names, etc.) fluctuate and oscillate widely over time. To get a more realistic curve, the betweeness scores from the various categories (Web, blog, forum), are combined and then a smoothing function is applied over a time window, ranging from 2 days to 10 days. The smoothing function could e.g. be a Kalman filter. Further, it should be appreciated that the weighting factor can be changed dynamically at any point of the temporal analysis and visualization process.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a flow chart depicting a first embodiment of the method of the present invention.

FIG. 2 is a visual depiction of the prediction results returned by the herein presented method of measuring trends in comparison to stock prices; and

FIG. 3 is a visual depiction of the results of the predictive quality of the herein presented method for stock “IBM”.

FIG. 4 is a visual depiction of a combined and smoothed trend curve that shows the results of the predictive quality of the herein presented method for stock “Salesforce” over a time window of ten days.

### DETAILED DESCRIPTION OF THE INVENTION

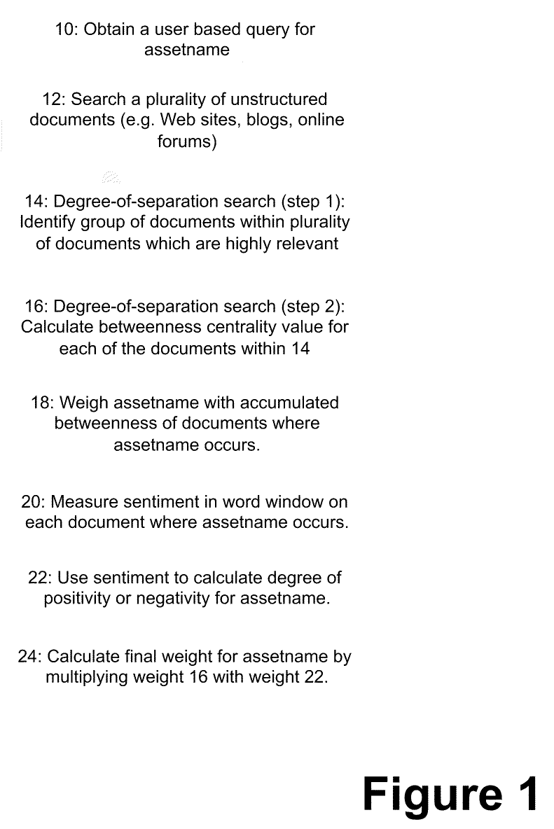

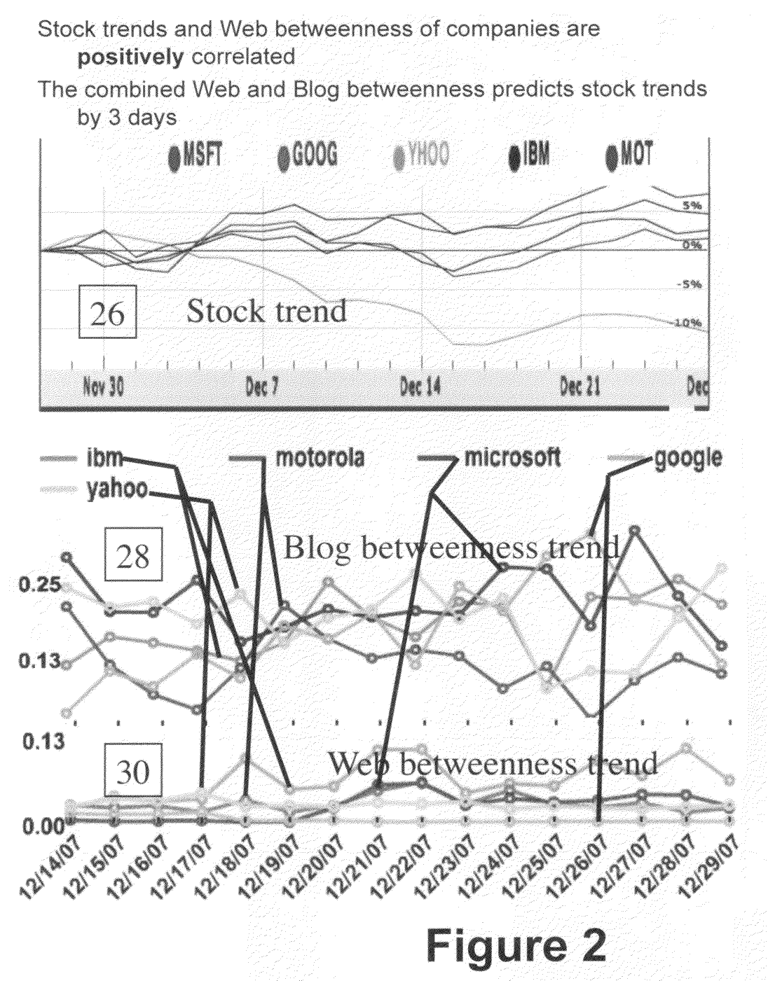

Now referring to the drawings, the method of the present invention determining asset value by analyzing a plurality of unstructured documents in order to identify a discrete group of those documents that have a particularly high degree of relevancy to a user based query is shown and generally illustrated at the flow chart in FIG. 1. Further, a method of providing a visual depiction of the predictive correlation between real asset value and the strength of the calculated prediction values is illustrated in FIGS. 2, 3, and 4.

Turning to FIG. 1, in the most general embodiment, the present invention provides a method 10 for analyzing and ranking interrelationships that exist within a plurality of unstructured documents to identify documents having a high relevancy to a user based query. In operation, the method 10 first provides for obtaining a user-based query “assetname” 12. Next, the user-based query is employed to search a plurality of unstructured documents 12 in order to identify at least a first group of documents that are most highly relevant to the user based query 14 using degree-of-separation search described in related patent application Ser. No. 11/867,094 filed Oct. 4, 2007: PROCESS FOR ANALYZING INTERRELATIONSHIPS BETWEEN INTERNET WEB SITED BASED ON AN ANALYSIS OF THEIR RELATIVE CENTRALITY. Once the first group of documents has been identified 16, a betweeness centrality ranking is calculated for each of the documents so that each of those documents can be ranked in descending order relative to one another based on their betweeness centrality value. The actor weight of “assetname” is then calculated by taking the normalized sum of the product of the term weights of “assetname” and betweenneess over all documents where assetname occurred 18. The term weight of assetname can be calculated by any standard information retrieval method such as TFIDF (term frequency inverse document frequency), or SVM (support vector machine) or similar. In each document where assetname occurs, sentiment in a word window of n words before and after assetname is calculated 20. This can be done by different methods, for example with a simple “bag of-words” approach, where common occurrences of assetname and positive words “good, great, wonderful, etc.”, and/or negative words “bad, horrible, sad, etc.”, are counted. Different sentiment detection algorithms can be employed for this. A sentiment factor is then calculated on a scale of −1 (entirely negative) to +1 (entirely positive) 22 for assetname. Actor weight 16 is multiplied by sentiment factor 22 to calculate a final prediction weight 24.

It is known in the art that the general concept of betweenness centrality has originally been defined in the context of social network analysis. In such a context, it measures the knowledge flow in a social network as a function of the shortest paths. In other words, betweeness centrality looks at the percentages of all shortest paths in a network that go through a given node. Accordingly, the concept of betweenness is essentially a metric for measuring of the centrality of any node in a given network. It may be characterized loosely as the number of times that a node needs a given node to reach another node. In practice, it is usually calculated as the fraction of shortest paths between node pairs that pass through the node of interest using the following function:

$${b}_{k} = {\sum }_{i , j} \frac{{g}_{ikj}}{{g}_{ij}}$$

where gᵢⱼ is the number of shortest paths from node i to node j, and gᵢₖⱼ is the number of shortest paths from i to j that pass through k. Betweenness ranges from 0, for nodes that are totally peripheral, to 1, for nodes that are on all shortest paths.

Within the scope of the present invention, the desired focus of the method of ranking unrelated documents is towards identifying and ranking a plurality of Internet Web based documents based on their relevancy to a user based query. In this regard, such unrelated documents may be selected from the group consisting of: documents, discrete elements of data, email communications, Web pages, online forum posts, online blog posts and actors that create any of the foregoing. More preferably, the unrelated documents are general Internet based Web content or Web pages.

In the most general terms, the present invention provides for performing a degree-of-separation search based on a user-defined scope or degree-of-separation limit. Once the results of the degree-of-separation search are returned, they are analyzed to determine the existing interrelationships that exist between all of the results. Then the results and their interrelationships are again evaluated using a betweeness centrality algorithm to provide each result with a betweeness centrality value that is relative globally to the entire body of results returned. Finally, the results are ranked based on the strength of their betweeness centrality values.

It is further possible within the scope of the present invention to employ the presently disclosed method to perform two parallel searches using two different user based search queries to compare performance of two or more different assets. In all regards, the two or more parallel searches are performed as described above. In the end, the results from the two or more searches are then all brought together and ranked in comparison to each other based on their betweeness centrality values, their term weight, and their sentiment factor.

Once the calculation is completed as described above, the present invention also provides for the results to be repeated over time to calculate a time series to identify a trend. As provided at FIGS. 2, 3, and 4, the time series consists of a series of prediction weights 24 where the weight is being calculated repeatedly at every point in time. Time interval is usually one day, but this depends on the application. Until now, these trend curves have been calculated retroactively, for data, which lies in the past. For example, by monitoring search activities for “Flu” in different cities, Google has been able to correlate flu outbreaks with search activity for “flu” in a particular city. FIG. 2 illustrates a stock trend curve 26, as well as the same trend curve calculated by method 10-24 analyzing the blogsphere 28, and the Web 30.

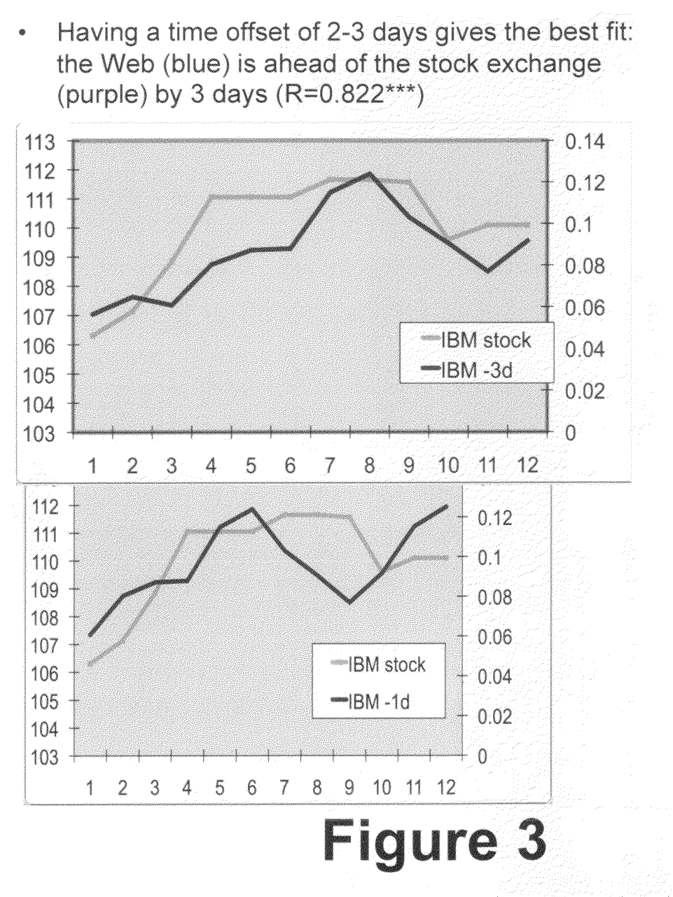

Subsequently, FIG. 3 gives a visual overview of the predictive capabilities of method 10-24. The stock price of IBM is compared with the time series of the prediction factor for assetname IBM. As the discussion on the Internet indicates intention and belief about an assetname, it predicts future performance of the asset.

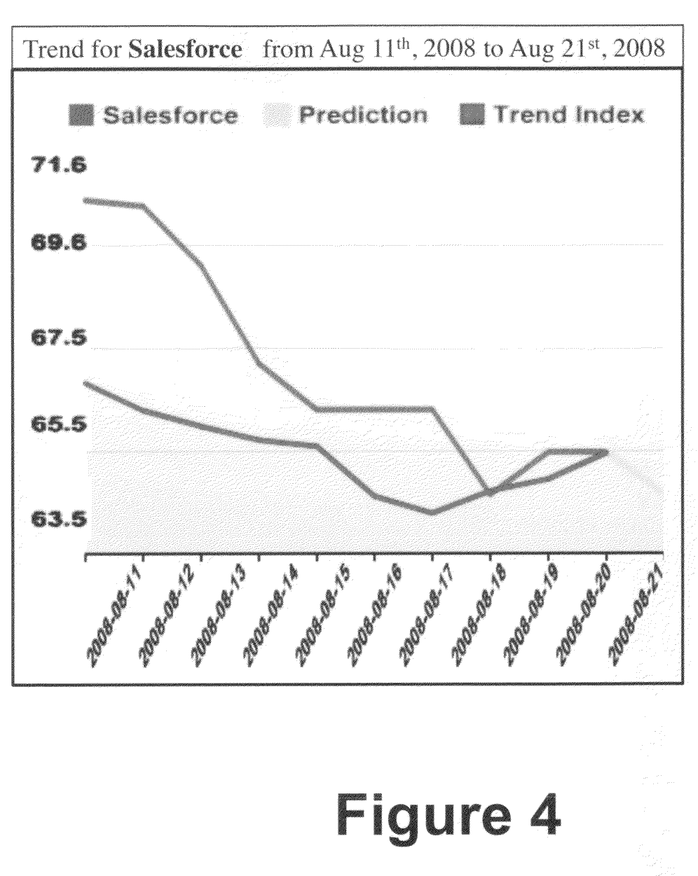

FIG. 4 gives a visual overview of the predictive capabilities of method 10-24. The trend curve comprises the betweeness values from the various categories (Web, blog, forum). The values are combined and then a smoothing function is applied over a time window, ranging from 2 days to 10 days. The weighting factors of the different categories are optimized by a sensitivity analysis. The weights can be changed dynamically at any point of the temporal visualization process. The time series consists of combined prediction weights 24 where the weight is being calculated repeatedly at every point in time.

Various information retrieval and text mining methods can be used to determine the sentiment of the context of the asset of interest (query term) in online forum posts or blog posts. One method is to manually read a large number of random posts (about 1000) and identify keywords or word pairs with positive and negative sentiment. These lists of positive and negative terms are used as start lists to be applied on online forum messages and blog posts. In each document where assetname (query term) occurs, common occurrences of assetname with terms of the positive and negative start lists are counted. Further refinements of the sentiment extraction methods can be restrictions of the algorithms on sentences or the consideration of a word window of n words before and after assetname.

For the purpose of illustration, the present invention for example can also be used to measure the changes in strength of a brand.

It should be appreciated that this analysis can be done using a snapshot in time or could be formed as a temporal visualization. In other words, the same search can be re-executed as a function of time in order to visually depict changes in the betweeness centrality of the relevant documents of interest over time. To get a more realistic curve the betweeness values from the various categories (Web, blog, forum), are combined and then a smoothing function is applied over a time window, ranging from 2 days to 10 days. Further, it should be appreciated that the weighting factor can be changed dynamically at any point of the temporal visualization process.

It can therefore be seen that the present invention provides a unique system that has broad applicability in predicting future trends through the results returned in a user based search through a body of unstructured documents. The ranking of each document from a traditional degree-of-separation search is further enhanced by analyzing their interlinking structure and their relative betweeness centrality as compared to the global selection of all of the returned results as well as the sentiment. For these reasons, the present invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for predicting asset value performance by analyzing a plurality of unstructured documents to identify documents having a high relevancy to a user based query, the method comprising the steps of:
obtaining a user based query;
searching said plurality of unstructured documents via said user based query by degree-of-separation search to calculate a betweenness value for each document containing the query term;
calculating a term weight for the search term in each said document;
calculating a sentiment factor for the documents within said group of documents; and
calculating a combined prediction factor based on betweeness value, term weight, and sentiment factor.

2. The method of claim 1, wherein said documents are Web pages.

3. The method of claim 1, wherein said documents are blog posts.

4. The method of claim 1, wherein said documents are online forum posts.

5. The method of claim 1, wherein said step of searching said plurality of unstructured documents comprises:
performing a traditional web search using an internet search engine.

6. The method of claim 1, wherein said documents are selected from the group consisting of: documents, discrete elements of data, email communications, Web pages, online forum posts, online blog posts and actors that create any of the foregoing.

7. The method of claim 1, further comprising:
obtaining a second user based query;
searching said plurality of unstructured documents via said second user based query;
identifying at least a second group of documents from within said unstructured documents, said second group of documents being most highly relevant to said second user based query;
calculating a betweeness centrality value ranking for each of the documents within said second group of documents; and
calculating a sentiment factor for each of the documents within said second group of documents
calculating a combined prediction factor based on betwenness value, term weight, and sentiment factor.
ranking first and second query term in descending order based on their relative prediction factor value.

8. The method of claim 7, wherein said step of calculating prediction factor values is repeated after a fixed period of time to create a temporal depiction of the changes in prediction factor values over time as a prediction curve. To get a more realistic curve the betweeness scores from the various categories (Web, blog, forum), are combined and then a smoothing function is applied over a time window, ranging from 2 days to 10 days.

9. The method of claim 8, with a discretionary number of query terms.

10. The method of claim 9, wherein said Internet based documents are selected from the group consisting of: Web pages, online forum posts, online blog posts and actors that create any of the foregoing.
